(19) United States
(12) Patent Application Publication
(10) Pub. No.: US 2018/0155857 A1
(43) Pub. Date: Jun. 7, 2018

(54) FIBER WITH SACRIFICIAL JUNCTIONS

(71) Applicant: College of William and Mary, Williamsburg, VA (US)

(72) Inventors: Hannes C. Schniepp, Williamsburg, VA (US); Sean R. Koebley, Richmond, VA (US)

(73) Assignee: College of William and Mary, Williamsburg, VA (US)

(21) Appl. No.: 15/833,007

(22) Filed: Dec. 6, 2017

Related U.S. Application Data
(60) Provisional application No. 62/431,001, filed on Dec. 7, 2016.

(51) Int. Cl. D02J 1/02; B29C 65/48

(52) U.S. Cl. CPC D02J 1/02; B29L 2031/731; B29C 65/4845

(57) ABSTRACT

A fiber composition, along with a method for toughening fiber compositions, are described. A fiber composition contains at least three loops along the length of said fiber, wherein the loops are bonded using sacrificial junctions comprising a bonding material that is chemically distinct from the fiber material. In some preferred embodiments, the loops have a circumference of at least one centimeter, and the bonding material is an ultraviolet light-cured adhesive. When a suitable force is applied, one or more sacrificial junctions can break without breaking the continuous fiber. The fiber compositions described herein have a toughness that is many times greater than the toughness of otherwise equivalent compositions of the fiber material which lack any such loops.

### CROSS-REFERENCE TO RELATED APPLICATIONS

The present application claims priority under 35 U.S.C. § 119(e) to (i) U.S. Provisional Patent Application No. 62/431,001, filed Dec. 7, 2016. The disclosure of this application is incorporated by reference herein.

### STATEMENT REGARDING FEDERALLY SPONSORED RESEARCH OR DEVELOPMENT

This invention was made with government support under Grant Number DMR-1352542, awarded by the National Science Foundation. The government has certain rights in the invention.

### FIELD OF INVENTION

The present application relates to novel fiber compositions having enhanced toughness, and methods for producing them. Particularly, the application relates to enhancing fibers by introducing sacrificial junctions.

### BACKGROUND

Fibers of enhanced toughness have long been sought by mankind for many different applications. One example is Kevlar®, which is widely used in bullet-proof apparel and has very high toughness. Another example is spider silk, which is a semicrystalline biopolymer with superb mechanical properties.

The recluse genus of spiders (Loxosceles) is a type of non-orbweaving spider that spins an especially curious silk: instead of a cylindrical strand like that of most other species, these spiders produce a flat ribbon only 40-80 nm thick. These flattened strands are as stiff and extensible as orb-weaving silk, and by their thinness, they are able to conform to complex surfaces in order to increase adhesion (see Schniepp, H. C. et al., “Brown Recluse Spider's Nanometer Scale Ribbons of Stiff Extensible Silk”, Advanced Materials (2013) 25, 7028-7032). We have recently determined that the recluse spider produces a biological metamaterial: its ribbon-like silk is woven into serial micro-loops by an intricate spinneret motion. This looped architecture enhances its capacity to absorb energy, making it an ideal candidate for biomimicry in future synthetic metamaterials.

A similar system was recently proposed by Pugno, who described a fiber system that dramatically enhances fiber toughness by introducing one or more slip knots into a fiber (Pugno, N. M. “The ‘Egg of Columbus’ for making the world's toughest fibres”, (2014) PloS One 9, e93079). When the fiber is placed under tension, the slip knot tightens and dissipates energy through friction as the fiber material passes through the knot.

### BRIEF SUMMARY OF THE INVENTION

A fiber composition is provided comprising a continuous fiber with at least three fixed loops along the length of said fiber, wherein said loops have a circumference of at least one millimeter, and wherein the loops are bonded into place using sacrificial junctions comprising a bonding material that is chemically distinct from the fiber material. In some preferred embodiments, the loops have a circumference of at least one centimeter, and the bonding material is an ultraviolet light-cured adhesive. When a suitable force is applied, one or more sacrificial junctions can break without breaking the continuous fiber. The fiber compositions described herein have a toughness that is at least two times greater than the toughness of otherwise equivalent compositions of the fiber material that lack any such loops. The sacrificial junctions have a breaking strength that is less than the breaking strength of the unlooped fiber, typically between 1% and 99% of the breaking strength of the unlooped fiber. In preferred embodiments, at least some of the sacrificial junctions have a breaking strength between 50% and 90% of the breaking strength of the unlooped fiber.

A method is provided for increasing fiber toughness, comprising introducing at least three loops along the length of a continuous fiber having a total length of at least 10 centimeters, wherein said loops have a circumference of at least one millimeter, wherein the loops are bonded using sacrificial junctions comprising a bonding material that is chemically distinct from the fiber material, wherein the sacrificial junctions are not the result of intramolecular bonding within the fiber material and have a breaking strength between 1% of the breaking strength of the unlooped fiber and 99% of the breaking strength of the unlooped fiber.

In some embodiments, the total fiber length is at least 1 meter, or at least 5 meters, or at least 100 meters. In some embodiments, the total number of loops is at least 10, or at least 20, or at least 100 loops. In some embodiments, there are at least four loops per meter of total fiber length. In some embodiments, the loop size is constant. In some embodiments, the average loop circumference is at least 1 mm, or at least 1 cm, or at least 1 inch, or at least 10 cm.

Suitable fiber compositions can be made, for example, on a continuous production line. In one exemplary approach, a long, continuous fiber is unrolled. At a specified position along the production line, a force is applied to the fiber to introduce a loop, and then an adhesive is quickly applied to fuse the loop's two contact points, with minimal relative strain until the adhesive is sufficiently set to allow continuous pulling from only one side. As the fiber moves along, additional loops are formed in the same manner as the first loop, and then the fiber is ultimately wound onto a roll. In some preferred embodiments, the adhesive that is applied is an ultraviolet light curing adhesive.

Any two points along the continuous fiber can be joined by adhesive bonding, wherein the resulting bond breaks when sufficient strain is applied. The “sacrificial” joint is able to break when a particular tensile load is applied to the fiber, without rupturing the fiber itself. When strain (length extension per initial length) is applied to the looped fiber, the non-looped portion experiences stress (force per unit area, σ). When the stress reaches the loop breaking strength (σₗ), which has to be below the fracture strength σᵤ, a loop adhesive junction is broken, causing the loop to unravel. The addition of the unraveled loop length to the stressed, non-looped portion of the fiber results in a stress reduction. As the fiber is further strained, it is once again stressed until 94 =σₗ and the next loop unravels. Finally, if all loops have been unraveled, the fiber may be stressed to its fracture strength aᵤ, at which point it breaks. The cyclical stressing and straining of the fiber due to the breaking of loop junctions means that the total energy required to fracture a looped strand is greater than that required to break a non-looped strand of equivalent mass, i.e., the looped strand has a greater toughness. In some embodiments, the total energy required to fracture a looped strand is at least two times greater than that required to break a non-looped strand of equivalent mass. In other embodiments, the total energy required to fracture a looped strand is at least five times greater than that required to break a non-looped strand of equivalent mass.

Toughness enhancement of a fiber via adhesively formed loops is desirable in a range of applications that seek to dissipate kinetic energy, especially in applications for which weight savings are given premium consideration and for which significant, plastic length gain is acceptable. Safety applications and defense systems against ballistic impact are representative examples. For instance, fibers of the present invention could be made into a net that could prove an ideal method for halting projectiles with considerable kinetic energy, as long as large strains are acceptable. Parachutes for aerospace applications are other examples where extreme energy dissipation is desirable without adding substantial mass.

In another embodiment, fiber compositions as described herein can be formed into a web designed to capture space debris. In another embodiment, fiber compositions as described herein can be formed into a structure resembling barbed wire and could provide the means for localized capture or retardation of movement.

### BRIEF DESCRIPTION OF THE FIGURES

FIG. 1 is a schematic diagram showing a representative looped fiber composition as described herein.

FIG. 2 is a stress-strain curve of a looped Loxosceles strand with L₀=5 mm. The first two peaks show the response of the apparent length of the strand until a loop unraveling event (*), and the last peak (having darker fill) shows the response of the unraveled strand.

FIG. 3 is a graph showing an experimentally measured stress-strain curve of a looped fiber with non-zero adhesive mass.

### DETAILED DESCRIPTION OF THE INVENTION

Suitable looped fiber compositions as described herein can in theory be made from any type of fiber, although the advantages conferred by the methods are more apparent for some fibers than others. Representative fibers include, but are not limited to, natural fibers such as cellulosic fibers (e.g., cotton, hemp, jute, flax, ramie, sisal) and animal fibers (e.g., wool, silk), and man-made fibers including metallic fibers (e.g., copper, aluminum), carbon fibers, glass fibers, synthetic polymer fibers (e.g., polyamide, polyvinyl chloride, polyolefin, aromatic polyamide, acrylic, polyester), and semi-synthetic fibers (e.g., cellulose acetate, rayon).

The methods provided have practical utility only when used with a continuous fiber having a length of at least 5 meters, having at least 3 loops along the length of said fiber, wherein (i) said continuous fiber is made from a fiber material; (ii) said loops have a circumference of at least 1 mm; and (iii) said loops are welded with a loop weld material that is chemically distinct from the fiber material such that the welded area is positionally fixed until sufficient force is applied such that the weld is broken. In some embodiments, production of the toughened fiber is facilitated when the loops have a circumference of at least one centimeter. In some embodiments, commercial viability is increased when the continuous number of loops is at least 20, or at least 100.

Suitable adhesives used to weld the loops can be any type of adhesive, but preferred adhesives are inexpensive, have quick setting times, and create sacrificial junctions having a breaking strength less than the strength of the selected unlooped fiber, preferably between 1% of the breaking strength of the unlooped fiber and 99% of the breaking strength of the unlooped fiber. Adhesives can be non-reactive adhesives such as drying adhesives, pressure-sensitive adhesives, contact adhesives, and hot-melt adhesives; or reactive adhesives such as multi-component adhesives or one-part adhesives.

Drying adhesives set through a drying process, and can be solvent-based adhesives or emulsion adhesives. Solvent-based adhesives entail a mixture of ingredients dissolved in a solvent, and upon evaporation of the solvent, the adhesive hardens. Pressure-sensitive adhesives form a bond by application of pressure (e.g., conventional tapes). Contact adhesives are generally used to form strong bonds with high shear resistance, and include compounds such as natural rubber and neoprene. Hot-melt adhesives comprise thermoplastic agents applied in molten form which solidify upon cooling to form sacrificial junctions as described herein.

Reactive adhesives include multi-component adhesives which harden when two or more different components react (e.g., epoxy adhesives), as well as one-part adhesives which harden via a chemical reaction with an external source, typically oxygen, light, or water.

Ultraviolet light curing adhesives, also known as light curing materials, are particularly well-suited to the methods of the invention because of their rapid cure times and strong bond strengths. For example, light curing materials can cure in as little as one second. They are often acrylic-based polymers.

Comparing the looped fiber compositions described herein to unlooped fibers (which can be used as starting materials), experimental and theoretical analysis of the looped material's tensile properties demonstrates significant enhancement in toughness due to the looped structure.

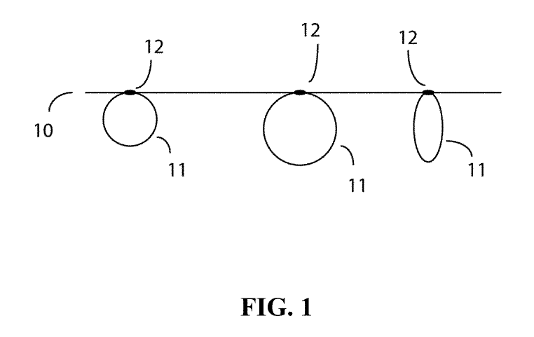

Referring now to FIG. 1, a continuous fiber 10 has a series of loops 11 along the length of said fiber. The loops are fixed into place with a series of sacrificial junctions 12, which are made with a loop weld material that is distinct from the chemical composition of the continuous fiber 10. When a sufficient force is applied, the sacrificial junctions are broken, resulting in a fiber having increased distance between its two ends. All loops can have the same size, or, as shown in FIG. 1, they can have different sizes. All loops can have the same shape, e.g., a circle, or they can have different shapes, as shown in FIG. 1. All sacrificial junctions can require the same breaking force, or they can have different breaking forces. In the representative diagram shown in FIG. 1, there are three loops having sacrificial junctions, but in other representative embodiments, the number of loops could be at least 10, at least 100, or at least 1000.

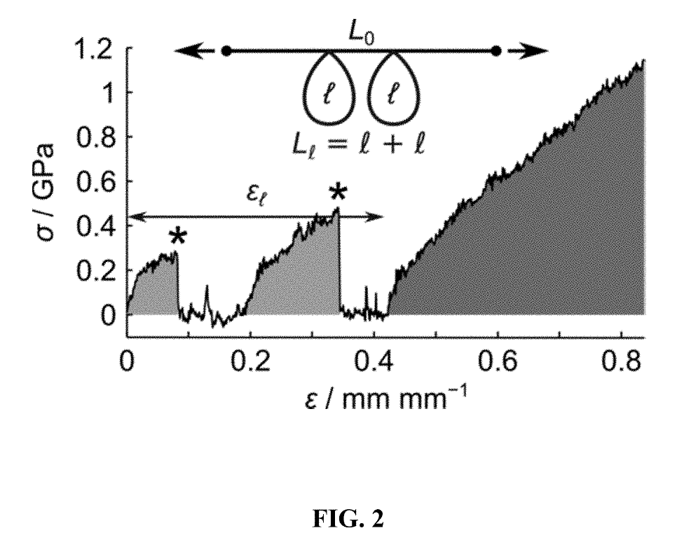

We have identified this enhanced toughness in experimental studies of the recluse genus of spiders (Loxosceles), which produce a biological metamaterial: its ribbon-like silk is woven into serial micro-loops by an intricate spinneret motion. This looped architecture enhances toughness. As shown in an example stress-strain curve of an experimentally measured strand of Loxosceles silk with two loops (FIG. 2), opening the first loop at a strain of ε≈0.1 and loop opening stress a fully relaxed the ribbon (first asterisk). Further extension exhausted the slack and built stress in the fiber until the next loop unraveled (second asterisk, FIG. 2). After the last loop was opened, the fiber was ultimately stretched to failure at stress σᵤ. Notably, this “strain cycling” needed to unravel serial loops significantly increases the total energy required to fracture the fiber (FIG. 2).

### EXAMPLES

The examples that follow are intended in no way to limit the scope of this invention but are provided to illustrate the methods of the present invention. Many other embodiments of this invention will be apparent to one skilled in the art.

### Example 1

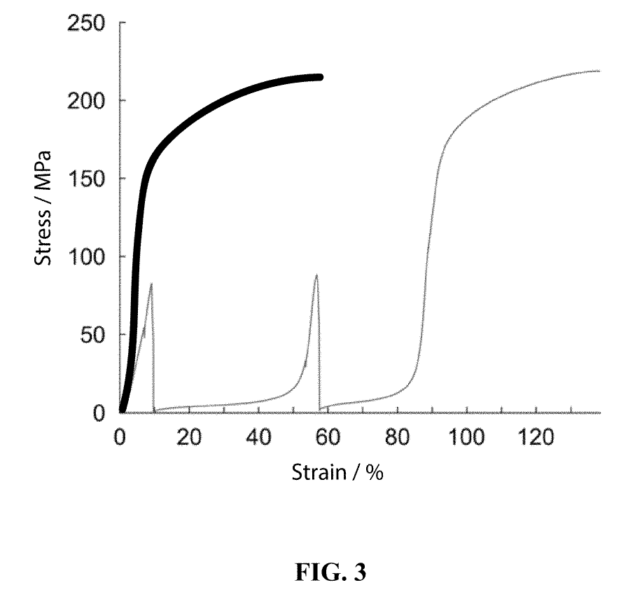

Loops (of approximately 1 cm in total perimeter length, also referred to herein as circumference) were introduced into 24 gauge copper wire by soldering using a 60/40 PbSn solder. The sample was then loaded into wire clamps in an Instron 5848 MicroTester with a 500 N load cell. After the sample's initial length was measured, it was extended at a rate of 1 mm/min until fracture, and the results are depicted in the stress-strain curve shown in FIG. 3. A control test was also conducted with a length of non-looped wire, and is shown as the dark (and thicker) curve in FIG. 3, while the results of the looped fiber appear as the lighter curve in FIG. 3. The significant breaking strength of the loops relative to the ultimate strength of the wire is apparent in the height of the stress peaks, indicating that the wire underwent substantial strain-cycling before fracture.

### Example 2

Looped strands of tape were fabricated that successfully released all hidden length before fracture and displayed no decrease in strength after loop unravelling. Heavy-duty trapping tape (with a width of 24.2 mm and thickness of 0.130 mm, comprising a polypropylene film reinforced with fiberglass fibres and coated on one side with a rubber-based adhesive) was utilized for this model study based on its elastic behaviour, ribbon morphology, and high resistance to torsional tearing due to its fibrillar composition. When a single loop of normalized size σ≈1.5 (wherein a is the loop circumference divided by the initially loaded length of the strand) was introduced, no significant decrease in strength was detected, and toughness was significantly increased. Tensile testing on these folded fibres was conducted using a 5848 MicroTester (Instron) with a 1 kN load cell. The mean toughness gain of 30% was in good agreement with the 22% gain predicted by a mathematical model, and much larger increases can be obtained in systems with more loops.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e. to at least one) of the grammatical object of the article. By way of example, “a fiber” means one fiber or more than one fiber.

Any ranges cited herein are inclusive, e.g., “between five percent and seventy-five percent” includes percentages of 5% and 75%.

We claim:

1. A fiber composition comprising:
A) a continuous fiber having a length of at least 5 meters, and
B) at least 3 fixed loops along the length of said fiber;
wherein said continuous fiber is made from a fiber material;
wherein said loops have a circumference of at least 1 millimeter; and
wherein said loops are welded with a loop weld material that is chemically distinct from the fiber material.

2. The composition of claim 1, wherein said loops are welded with an ultraviolet light curing adhesive.

3. The composition of claim 1, wherein said continuous fiber comprises a fiber selected from the group consisting of natural fibers, man-made fibers, and semi-synthetic fibers.

4. The composition of claim 1, wherein said composition comprises at least ten loops along the length of said fiber;
wherein said loops have a circumference of at least one centimeter; and
wherein said composition has a toughness that is at least two times the toughness of an otherwise equivalent composition of the fiber material that lacks any welded loops.

5. A method for enhancing toughness of a fiber composition comprising the steps:
A) selecting a continuous fiber having a length of at least 5 meters, and
B) introducing at least three fixed loops along the length of said fiber;
wherein said continuous fiber is made from a fiber material;
wherein said loops have a circumference of at least 1 millimeter; and
wherein said loops are welded with a loop weld material that is chemically distinct from the fiber material.

6. The method of claim 5, wherein at least 10 fixed loops are introduced along the length of said fiber.

7. The method of claim 5, wherein said loops have a circumference of at least one centimeter.
